(19) United States
(12) Patent Application Publication
(10) Pub. No.: US 2004/0067354 A1
(43) Pub. Date: Apr. 8, 2004

(54) Tray for vapor phase step

(75) Inventors: Kazuyuki Ohya, Tokyo (JP); Takeshi Nobukuni, Tokyo (JP); Norio Sayama, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: MITSUBISHI GAS CHEMICAL COMPANY, INC.

(21) Appl. No.: 10/670,008

(22) Filed: Sep. 25, 2003

(30) Foreign Application Priority Data
Sep. 27, 2002 (JP) 283146/2002

(51) Int. Cl. B32B 3/26

(52) U.S. Cl. 428/304.4; 428/698; 428/332

(57) ABSTRACT

A tray for a vapor phase step in which a heat-resistant thermosetting resin is intimately bonded and impregnated to/into surfaces, including inner pore wall surfaces, of an inorganic continuously porous sintered body having a thickness of 0.5 to 10 mm and an open porosity of 5 to 50% and a thin film of a super heat-resistant thermoplastic resin is formed thereon, and a process for the production thereof.

### FIELD OF THE INVENTION

The present invention provides a tray for a vapor phase step obtained by using a continuously porous ceramic impregnated with a heat-resistant resin. A semiconductor substrate is supported or held by the above tray, which actualizes a continuous use through steps without any cracks.

### PRIOR ARTS OF THE INVENTION

In recent years, it is required to decrease electronic machines and equipment in thickness and weight, and these machines and equipment are decreasing in thickness further and further, as is typically found in cellular phones and IC cards. Further, it is required to thin a semiconductor in view of an increase in speed and a decrease in power consumption.

Although depending upon the kind of a semiconductor substrate and the kind of an element to be formed, a semiconductor substrate which has a thin thickness of approximately 30 μm or less can be lightly bent.

However, when a semiconductor substrate or ceramic substrate thinned in advance is used and an electric circuit is formed on only one surface thereof, the substrate warps or distorts since the thermal expansion coefficient of materials for forming the circuit, particularly metals such as aluminum, copper and gold, differs from that of the semiconductor substrate such as a silicon wafer or the ceramic substrate by 5 to 15×10⁻⁶K⁻¹. For this reason, not only it becomes impossible to form a circuit on the reverse surface but also it becomes impossible to carry out even all steps for the front surface in some cases. Therefore, it is substantially impossible to use the substrate thinned in advance.

For the above reason, conventionally, there is adopted a method in which an electric-circuit-forming step requiring a high temperature is mainly conducted on one surface of a semiconductor substrate having a thickness of approximately 0.25 to 0.725 mm, then the above electric-circuit-formed surface is protected by bonding the surface to a supporting substrate and the other surface (reverse surface) is polished to thin the substrate to a predetermined thickness.

Although depending upon the kind of the semiconductor substrate and the kind of an element to be formed, if the thickness of a substrate which is thinned is approximately at least 150 μm, it is possible to carry out a desired processing step on the reverse surface (polished surface) even if distortion occurs to some extent.

However, since the above thinned substrate is extremely fragile, a problem is that the substrate is easy to break during transportation in a reverse surface processing step (generally, a vapor phase step composed of a vacuum deposition or sputtering and a heat treatment), which worsens a product yield.

For avoiding the above breakage, it is required to decrease the number of handling of the thinned semiconductor substrate alone, as much as possible.

Means therefor typically includes the following two methods.

(1). A production method in which the vapor phase step is carried out while bonding and holding the semiconductor substrate to/with the supporting substrate used for the thinning.

(2). A production method in which after thinning, the semiconductor substrate is placed on a tray or a susceptor for a vapor phase step and the vapor phase step is carried out.

In the production method (1), the thinned semiconductor substrate is directly applied to the vapor phase step while the substrate is held with the supporting substrate, it is finished as a bare chip, and then the bare chip is peeled off to become a product. As a result, since the polishing for thinning and the vapor phase step are carried out under the bonding state, a high product yield can be obtained if peeling off after the step is possible. Further, the production method (1) has a characteristic feature in that the thinnest thickness applicable to this method is approximately 20 μm.

However, the number of the applied steps is so many and the conditions are various and extremely severe with an organic substance. Therefore, even when the method (1) can be carried out, it is necessary to select a condition range satisfying all conditions where conditions for respective products and working step conditions thereof are optimum conditions respectively. Therefore, the production method (1) has defects that its application range is narrow and that it is insufficient in general versatility.

In contrast, in the production method (2), the thinned semiconductor substrate is peeled off from the supporting substrate, the substrate is placed on the tray or susceptor for the vapor phase step and transported, and the substrate placed on the tray or susceptor is put into and taken out from the vapor phase step. As a result, the production method (2) has an excellent characteristic feature in that it is applicable to every condition range which the material properties of the tray or susceptor used allow.

However, although depending upon the kind and size of the semiconductor substrate, there is a limitation that the thickness thereof is approximately 100 μm from the condition that transfer and transportation are possible. Further, from the material properties of the tray or susceptor used, a vapor phase step to which a metal material such as a material made of stainless steel is applicable and a vapor phase step to which ceramics such as silica glass are applicable are present. It is necessary to exchange trays or suscptors between the steps, i.e. to transfer the substrate. A problem is that the substrate is liable to break during the transfer.

Further, a material applicable to the above-mentioned two steps includes silicon carbide (SiC). However the silicon carbide has a problem that proper processing is difficult. Further, JP-A-07-058041 publication discloses a carbon having a SiC coating formed thereon. However, there is a defect that warpage, distortion or deformation occurs due to heat and increases due to repetition of heat treatment. A use of a supporting member such as silicon carbide is proposed for correcting the above distortion and maintaining the flatness, while breakage due to a thermal shock or a difference of thermal expansion coefficient is liable to occur.

### SUMMARY OF THE INVENTION

It is an object of the present invention to provide a tray or susceptor which is applicable to both of a vapor phase step to which a metal material such as a material made of stainless steel is applicable and a vapor phase step to which ceramics such as silica glass are applicable, as a tray or susceptor for a vapor phase step used in the above production method (2).

The present inventors have made diligent studies for overcoming the above object from the viewpoint that a technique for a metal-foil-clad resin composite ceramic board may be used and, as a result, reached to the present invention.

That is, the present invention provides a tray for a vapor phase step in which a heat-resistant thermosetting resin is intimately bonded and impregnated to/into surfaces, including inner pore wall surfaces, of an inorganic continuously porous sintered body having a thickness of 0.5 to 10 mm and an open porosity of 5 to 50% and a thin film of a super heat-resistant thermoplastic resin is formed thereon.

In the present invention, the inorganic continuously porous sintered body is preferably selected from the group consisting of an aluminum nitride-boron nitride (AlN-h-BN) composite, an aluminum nitride-silicon carbide-boron nitride (AlN-SiC-h-BN) composite, a silicon nitride-boron nitride (Si₃N₄-h-BN) composite, an alumina-boron nitride (Al₂O₃-h-BN) composite, β-silicon carbide (β-SiC) and wollastonite, the heat-resistant thermosetting resin is preferably selected from resins whose cured products have a thermal decomposition starting temperature of at least 400° C. and the heat-resistant thermoplastic resin is preferably selected from resins which have a thermal decomposition starting temperature of at least 500° C.

Further, the present invention provides a process for the production of a tray for a vapor phase step, comprising surface-treating an inorganic continuously porous sintered body having a thickness of 0.5 to 10 mm and an open porosity of 5 to 50% for resin impregnation, impregnating the inorganic continuously porous sintered body with a thermosetting resin to intimately bond the thermosetting resin to surfaces thereof including inner pore wall surfaces, machining the sintered body into a predetermined tray shape, impregnating the machined sintered body with a solution of a super heat-resistant thermoplastic resin as a final impregnation, and subjecting the sintered body to heating, drying and heat-treatment to form a thin super heat-resistant thermoplastic resin layer.

Further, the present invention provides a process for the production of a tray for a vapor phase step, comprising impregnating an inorganic continuously porous sintered body having an open porosity of 5 to 50% with a thermally decomposable resin, cutting the sintered body to a thickness of 0.5 to 10 mm, then machining the sintered body into a predetermined tray shape, decomposing and removing the thermally decomposable resin, cleaning the sintered body, surface-treating the sintered body for heat-resistant resin impregnation, impregnating the sintered body with a heat-resistant thermosetting resin to intimately bond the resin to surfaces thereof including inner pore wall surfaces, further impregnating the sintered body with a solution of a super heat-resistant thermoplastic resin, and subjecting the sintered body to heating, drying and heat-treatment to form a thin super heat-resistant thermoplastic resin layer.

In the production processes of the present invention, the surface treatment for heat-resistant resin impregnation is preferably a surface-treatment including the inner pore wall surfaces in which an organic metal compound solution is impregnated, air-dried, dried, heated and thermally decomposed, and the same inorganic continuously porous sintered body, heat-resistant thermosetting resin, and heat-resistant thermoplastic resin(thermosetting resin) as those described above are preferably selected.

### DETAILED DESCRIPTION OF THE INVENTION

The structure of the present invention will be explained hereinafter.

A thinned semiconductor wafer is generally curved. This curve (warpage, distortion) is caused because at least one layer is formed on the surface and the thermal expansion coefficient of a foundation is generally different from that of the at least one layer and that of an interlayer. The above distortion enlarges through a vacuum step, a heat treatment step, and the like.

Further, the distortion also occurs by heating or cooling, particularly unevenness of heating.

The vacuum step, e.g. deposition or sputtering of a metal, is heating of a deposition or sputtering surface by metal ions. At this time, when a balance between the above heating and an auxiliary heating from the reverse surface is not taken, the semiconductor wafer curves. This curve enlarges due to a temperature difference and the like.

The tray of the present invention carries a thinned semiconductor wafer and protects it from breakage during transportation. It is applicable to both steps of the conventional metal tray and ceramic tray.

The present invention uses an inorganic continuously porous sintered body impregnated with a heat-resistant resin.

Generally, an inorganic continuously porous sintered body can not be directly applied to the vapor phase step including a vacuum deposition and sputtering. One of the reasons is as follows. A moisture absorption content is fixed as a structural water, a crystal water or other-shaped water and it is gradually released under a high vacuum and a high temperature so that the degree of vacuum does not easily reach to a desired vacuum degree. Further, even if the water is completely removed, the fixation of water proceeds rapidly by only allowing the sintered body to stand in a room. Furthermore, naturally, the adsorptions of components other than water can occur in pores. Impurities gradually accumulate in the pores and the accumulated impurities are instantly released at random or by a certain chance. That is, it can be said that the inorganic continuously porous sintered body has a contamination trap part which is a cause of contamination.

The impregnated heat-resistant resin of the present invention blocks the above moisture absorption point of the inorganic continuously porous sintered body and prevents such water from generating. Further, it seals holes, into which substances as a cause of contamination accumulate, in the pores. The impregnated resin is intimately bonded to the surfaces including inner wall surfaces of the pores, and the fixation of water, which is called a structural water, etc., is prevented by making the intimately-bonded resin not be easily peeled off from the inner wall surfaces of the pores. Further, it is preferred that no pore is present in view of the suppression of the accumulation of contamination so that the resin impregnation rate is enlarged as much as possible. To enlarge the resin impregnation rate as much as possible in a practically possible range minimizes the possibility of the accumulation of contamination.

Here, according to a measurement method for the resin impregnation rate, etc., naturally, there are some cases where it can be said that the above sintered body is not a complete impregnation body. Some persons object the above description on the basis of these cases. The physical meaning of a measured value is already decided by its measuring method. An obtained value is justifiable only in the range of the physical meaning of the measuring method. The above objection is merely a silly talk of a data-dependent person who forgets the above natural logic or wants to ignore it intentionally and who unconcernedly says, as a recent typical example, “This result was obtained with the computer and therefore it is correct” and intends to insist on it that this is justifiable.

The inorganic continuously porous sintered body used in the present invention has a thickness of 0.5 to 10 mm and an open porosity of 5 to 50 vol %, preferably 5 to 35 vol %, particularly 10 to 30 vol %. The close porosity is 2 vol % or less and a lesser close porosity is more preferred. Further, the average pore diameter is 0.05 to 10 μm, preferably 0.1 to 5 μm. Moreover, the thermal conductivity of the tray is preferably larger, since heating from a surface (reverse surface) not to be subjected to vacuum deposition or sputtering is carried out for preliminarily heating to a predetermined temperature in the vapor phase step or for preventing the occurrence of distortion based on the unevenness of the heating of the wafer, as is described before.

In the present invention, specifically, the inorganic continuously porous sintered body includes an aluminum nitride-boron nitride (AlN-h-BN) composite, an aluminum nitride-silicon carbide-boron nitride (AlN-SiC-h-BN) composite, a silicon nitride-boron nitride (Si₃N₄-h-BN) composite, an alumina-boron nitride (Al₂O₃-h-BN) composite, β-silicon carbide (β-SiC) and wollastonite. Particularly, aluminum nitride types are preferred.

The heat-resistant resin used in the present invention is not required to exhibit high strength in a vapor phase step atmosphere to be used, while it is a heat-resistant resin which does not thermally decompose substantially, can be repeatedly used and can be impregnated into the inorganic continuously porous sintered body.

When the temperature to be used is up to approximately 300° C., examples include heat-resistant epoxy resins and cyanato resins. When the temperature to be used is up to approximately 450° C., examples include a ladder type silicon oligomer (supplied by Owens-Illinois, trade name; Glass Resin GR908, GR-650, etc.) and a polyimide resin oligomer (Skybond, etc.).

Moreover, super heat-resistant resins of more than 500° C. are commercially available. Of these resins, it is confirmed that a solution of a polybenzimidazole resin can be impregnated, and it can be used. Similarly, it is presumed that a resin whose impregnation properties (when it is used alone or it is impregnated as a topcoat on the above ladder type silicon oligomer, etc.) can be confirmed exists. If such a resin is confirmed, it can be used like the solution of the polybenzimidazole resin.

Furthermore, among the above-described heat-resistant resins of approximately 450° C. to 480° C., there are some resins whose main bonding structure itself has a heat resistance of more than 500° C. As for these resins, an improvement in heat resistance is attempted by an increase in molecular weight or removal of unreacted portions by a more complete reaction. Therefore, there is a possibility that these resins can be greatly improved in heat resistance by a contrivance of a vacuum heat treatment or an impregnation method or a combination under practical working conditions.

Then, an example of the production steps of the present invention will be explained.

First, the resin impregnation step of the present invention is explained according to an example using a block of the inorganic continuously porous sintered body. The above step includes the following (1-1) to (1-6). Each of the steps of (1-5) and (1-6) is independently repeated a plurality of times as required. The last step is (1-6).

(1-1). Impregnation of the block of the inorganic continuously porous sintered body with a rosin wax solution and drying

(1-2). Slicing the block into a thin board having a predetermined thickness.

(1-3). Removal of the rosin wax by heat treatment, and cleaning by firing at 600-850° C.

(1-4). Impregnation with a solution for surface treatment, air-drying, drying by heating, and thermal decomposition at 600-850° C.

(1-5). The first resin solution impregnation and drying by heating.

• • •

(1-6). The last impregnation with a heat-resistant thermoplastic resin solution, and drying by heating • heat treatment.

Then, processing to a tray shape of the present invention includes the following (2-1) to (2-4).

(2-1). Flat plate processing to a tray thickness.

(2-2). Concave processing and outline processing into a tray shape.

(2-3). Additionally, processing of an auxiliary part such as a cover attaching and detaching part.

(2-4). Finish polishing processing, etc.

Here, concerning the resin impregnation step (1) and the processing step (2), the resin impregnation steps (1-1) and (1-2) are carried out as the first steps of all the above steps, and the resin impregnation step (1-6) is carried out as the last step of all the above steps. Further, the resin impregnation steps (1-3), (1-4) and (1-5) area series of steps. Typical examples of the steps includes the following (a) and (b).

(a) Steps (1-1)-(1-5)→steps (2-1)-(2-4)→step (1-6).

(b) Steps (1-1)-(1-2)→steps (2-1)-(2-4)→steps (1-3)-(1-6).

Each of the above steps will be simply explained.

In the step (1-1), the rosin wax is intimately bonded and impregnated to/into pore surfaces including their insides. This intimate bonding impregnation improves the impact resistance and prevents the occurrence of cracks and crackles. Further, in the case of an aluminum nitride-based inorganic continuously porous sintered body which deteriorates by water or the like, the above intimate bonding impregnation improves the water resistance thereof and makes it less deteriorative. As a result, even when the aluminum nitride-based inorganic continuously porous sintered body which deteriorates by water is used, the slicing processing of the step (1-2), which is a long-term processing, can be carried out with substantially inhibiting deterioration.

The step (1-2) is the production of a flat board having a desired thickness.

The step (1-3) is a preprocessing. A completely clean, inorganic continuously porous sintered body is prepared.

The step (1-4) imparts affinity to the resin to the surfaces including inner pore surfaces for the resin impregnation. This surface treatment for the (heat-resistant) resin impregnation is preferably a method in which an organic metal compound solution is impregnated and it is air-dried, dried, heated and thermally decomposed.

The step (1-5) is impregnation of the resin. The resin is impregnated into the pores of the inorganic continuously porous sintered body which has been improved in affinity and cleaned.

The step (1-6) is a step in which the heat-resistant thermoplastic resin solution is impregnated and it is dried by heating and thermally treated. This step is the last step of the resin impregnation. Further, naturally, the step (1-6) can be carried out at a midway step in the production of the tray and it is selected as required. However, it is preferred to certainly carry out the step (1-6) as the last step of the tray production. By the step (1-6) as the last step, a thin resin layer having a thickness of generally 5 μm or less, typically about 0.5 to 3 μm, is formed on the surfaces of the tray. The formation of the thin resin layer is carried out as the last stage of the impregnation step, so that the thin resin layer becomes a coating which is extremely strongly intimately bonded to the base material as compared with a method in which a coating film is independently formed. Furthermore, the thin resin layer prevents the semiconductor substrate and the ceramic from being brought into direct contact with each other and suppresses the occurrences of scratches caused by rubbing of the tray surface and the semiconductor substrate against each other due to a difference in thermal expansion coefficient or the unevenness of heating.

The flat board processing to a tray thickness of the step (2-1) prepares a board having high flatness. It is an indispensable step for enabling a high-accuracy processing.

The step (2-2) is a processing to a tray shape. There are carried out a concave processing, an outline processing, and other processings, e.g., placement of a wafer onto the tray, and processing of a penetration hole for a pin to be used for taking out, or the like.

The step (2-3) is generally carried out without any distinction between the step (2-2) and the step (2-3). It is a processing step of an indivisual auxiliary part, such as a cover attaching and detaching part, based on the design specification of the tray.

The step (2-4) is a finishing polishing processing and the like. In particular, the processing is carried out such that the degree of surface roughness of a cut portion formed by cutting carried out for the shape processing is in a predetermined range of the surface roughness degree.

The tray of the present invention is produced by the above steps.

Up to this point, the tray of the present invention has been explained with emphasis on a case which is applied for a method for producing a thin semiconductor, while the tray of the present invention is preferably usable for a vapor phase step such as a plasma CVD, sputtering, dry etching and PVD (physical vapor deposition) in a semiconductor device producing step, for producing a semiconductor on a ceramic substrate and for steps of a low-strength compound semiconductor other than a silicon wafer, such as particularly GaAs, GaP and GaN.

Further, when a tray cover is fixed to the tray with a fixture (clamp) for the tray before use, the shape of the tray cover can be held by the tray. Therefore, the tray cover is usable so long as it has a strength having a self-shape retaining function at a use temperature.

Such a material includes a super heat-resistant thermosetting or thermoplastic resin. It includes trade name “Vespel” (supplied by DuPont) and trade name “Upimol” (supplied by Ube Industries. Ltd.) as a polyimide resin and includes trade name “Celazol” (supplied by Clariant Japan) as a polybenzimidazole resin.

Then, the production process of the tray cover of the present invention will be explained.

An example thereof is explained concerning a case using a super heat-resistant resin molded article having a cylindrical shape, and it is produced by the following (1-1)-(1-3).

(1-1). The superheat-resistant resin molded article is cut so as to have an outline diameter substantially the same as that of the tray for the vapor phase step and a thickness of 1 to 15 mm which corresponds to a necessary width.

(1-2). Then, preferably, a plurality of fixing parts (clamp parts) for fitting the tray cover into the tray for the vapor phase step so as to allow free attachment and detachment are prepared.

(1-3). A covering portion is cut into rings having a desired thickness of 0.1 to 1 mm.

Further, in the case of a super heat-resistant resin, a predetermined molded article can be produced by high-temperature and high-pressure molding of a raw material powder. The following (2-1)-(2-4) show an example thereof.

(2-1). There is prepared a mold having an outline diameter substantially the same as that of the tray for the vapor phase step and a thickness of 1 to 15 mm which corresponds to a necessary width.

(2-2). Preferably, at least three fixing parts (clamp parts) for fitting the tray cover into the tray for the vapor phase step so as to allow free attachment and detachment are prepared as a unit.

(2-3). A powder molding material is placed in the above mold and then heated and pressurized to obtain an article having a predetermined shape.

(2-4). Finishing processing to a desired size is carried out by cutting and polishing, and the like.

### EXAMPLES

The present invention will be concretely explained with reference to Examples hereinafter.

### Example 1

As an inorganic continuously porous sintered body, a disk having a thickness of 25 mm and a diameter of 157 mm (to be referred to as “AN1” hereinafter) made of an aluminum nitride-boron nitride-based continuously porous sintered body (h-BN content 13%, bulk density 2.70 g/cm³, true porosity 13.0 vol %, average pore diameter 0.48 μm) was prepared.

A rosin wax solution (solid content concentration 20 wt %, to be referred to as “S1” hereinafter) of isopropanol (IPA) was prepared.

The AN1 was placed in a container, and the container was placed in an impregnation vessel of a pressure-reducible impregnator. The solution S1 was poured into the container. Reduction of the pressure in the impregnation vessel was started. While a pressure immediately before boiling of IPA was maintained at room temperature (25° C.), an ultrasonic vibration was properly given to carry out impregnation for 3 hours.

The AN1 was taken out, allowed to dry at room temperature for 5 hours, and then dried with a dryer at 80° C. to obtain a rosin-wax-impregnated AN1.

The rosin-wax-impregnated AN1 was sliced with a multi-blade saw to obtain a slice substrate having a thickness of 1.8 mm (to be referred to as “AN1-S” hereinafter).

5% of aluminumtris (ethylacetylacetate) (trade name; ALCH-TR, supplied by Kawaken Fine Chemicals Co., Ltd.), 30% of a mixed xylene and 65% of IPA were mixed to prepare a surface-treatment agent solution (to be referred to as “A1” hereinafter).

The above-obtained slice substrate AN1-S (1.8 mm) was placed in a dryer and dried by stepwise temperature-increasing of 150° C./30 minutes+180° C./30 minutes+200° C./30 minutes, to remove the rosin wax.

The resultant slice substrate AN1-S was transferred onto a board made of alumina. Then, it was temperature-increased from 200° C. to 700° C. at a rate of 8° C./minute in a nitrogen-atmosphere furnace, maintained at 700° C. for 10 minutes and allowed to cool, to obtain a cleaned AN1-S.

The cleaned AN1-S was placed in a container, and the container was placed in an impregnation vessel of a pressure-reducible impregnator. The surface-treatment agent solution A1 was poured into the container. Reduction of the pressure in the impregnation vessel was started. While a pressure immediately before boiling of IPA was maintained at room temperature (25° C.), an ultrasonic vibration was properly given to carry out impregnation for 30 minutes. Then, it was taken out to obtain an aluminum-chelate-compound-impregnated cleaned AN1-L.

A resin solution (to be referred to as “Resin R1” hereinafter) of 60% of a ladder type silicone oligomer (supplied by Owens-Illinois, trade name; Glass Resin GR908, polyorganosilsesquioxane, side-chain methyl group/side-chain phenyl group=1/4) in 40% of a mixed xylene was prepared.

The above-obtained aluminum-chelate-compound-impregnated cleaned AN1-L was allowed to dry at room temperature (air-dried), then placed in a dryer and dried by stepwise temperature-increasing of 120° C./60 minutes+180° C./30 minutes+250° C./30 minutes. The dried AN1-L was transferred onto a board made of alumina, temperature-increased from 250° C. to 750° C. at a rate of 8° C./minute, maintained at 750° C. for 30 minutes and then allowed to cool, to obtain a cleaned AN1-L having open pores on the inner surfaces of which an aluminum oxide was intimately bonded. (to be referred to as “AN1-A” hereinafter).

The above AN1-A was placed in an impregnation container of a pressure-reducible impregnator. Further, the above-prepared Resin R1 was placed in a resin container of the pressure-reducible impregnator.

Reduction of the pressure in the impregnation vessel was started. After both the pressure in the impregnation vessel and the pressure in the resin container were reduced to 0.665 kPa or lower, the AN1-A was maintained at 20° C. for 5 minutes. Then, the Resin R1 was gradually added from the bottom of the impregnation container and, when the generation of bubbles became small, an ultrasonic vibration was given. The AN1-A was maintained for 3 hours with repeating the above operation.

The AN1-A impregnated with the Resin R1 was taken out from the pressure-reducible impregnator. The resin on the surface was removed by dropping and the AN1-A was allowed to dry for 16 hours. Then, it was dried with a hot-air dryer by stepwise temperature-increasing of 120° C./60 minutes+180° C./30 minutes+250° C./30 minutes, and then cooled down to room temperature. Steps of ultrasonic impregnation, natural-drying and stepwise drying were carried out two times in the same manner as above except that the impregnation time of the Resin R1 was changed to 12 hours. The impregnation was carried out three times in total, to obtain a resin-impregnated AN1-A.

A reverse cushion having a thickness of 2.0 mm and a width of 50 mm was disposed around the above resin-impregnated AN1-A. 0.4 mm-thick heat-resistant aluminum alloy sheets having a Teflon (trademark)-coated surface were disposed on both surfaces of the above set of the AN1-A and the reverse cushion. The resultant set was disposed, as materials to be laminated, between hot press plates so as to prepare a contact-condition with substantially no pressure loading. Pressure reduction of a press atmosphere and heating of the hot press plates were started.

When the temperature of the resin-impregnated AN1-A reached to 150° C., loading of a pressing pressure was started to adjust a surface pressure to 0.3 MPa (nearly equal 3 kg/cm²) The resin-impregnated AN1-A was temperature-increased and heated up to 350° C. at a rate of 6° C./minute and maintained at 350° C. for 1 hour. Then, the heating was terminated, and it was allowed to cool to obtain a resin-impregnated AN1-A of which the resin was cured (to be referred to as “R1-AN1” hereinafter)

The obtained R1-AN1 was surface-polished to a thickness of 1.55 mm using a green carbon grain size #320 (SiC grain, supplied by Fujimi Incorporated, product name; GC#320). Further, it was surface-polished to a thickness of 1.50 mm with a lapping machine (supplied by Okamoto machine tool works, Ltd., product name; GRIND-X, SPL15T, number of revolution 600 rpm, load 7 kg) using a green carbon grain size #1200 (supplied by Fujimi Incorporated, product name; GC#1200), to give a flattened R1-AN1.

The flattened R1-AN1 was processed with a CNC lathe into a predetermined tray shape which had an outermost diameter of 152 mm, a peripheral wall height of 0.5 mm, a peripheral wall thickness of 0.7 mm, a mounting part diameter of 150 mm, a mounting part width of 0.7 mm, a bottom face thickness of 0.5 mm, and an oblique-cut bottom face peripheral part whose width was 1.0 mm and height was 0.5 mm, and had 8 bottom face holes having a size of 30 mm each.

Then, it was ultrasonically cleaned in pure water for 15 minutes and then dried by a dryer at 150° C. for 3 hours.

A polybenzimidazole solution (trade name; Celazol MRS PBI type, N,N-dimethylacetamide solution, solid content 10%) was placed in an impregnation container of a pressure-reducible impregnator and preheated up to 60° C.

The cleaned and dried tray was taken out from the dryer with keeping its temperature of 100° C. It was placed in the 60° C.-heated impregnation container of the pressure-reducible impregnator, the pressure in the system was reduced and reduced-pressure impregnation was continued until the generation of bubbles from the tray was terminated.

After the completion of the impregnation, the tray was taken out from the pressure-reducible impregnator. The resin solution on the surface was wiped off and then the tray was air-dried whole day and night. Then, it was placed in a dryer of 100° C., heated for 30 minutes, then heated up to 180° C. at a temperature-increasing rate of 2° C./minute, then heated up to 250° C. at a temperature-increasing rate of 5° C./minute, and maintained at 250° C. for 1 hour, to obtain a heat-resistant tray.

The obtained heat-resistant tray was placed in a furnace set at 300° C. in which a nitrogen gas had been substituted, heated for 30 minutes, then heated up to 450° C. at a temperature-increasing rate of 5° C./minute, maintained at 450° C. for 1 hour and then allowed to cool down to 120° C. At this point, the heat-resistant tray was taken out from the furnace. The tray was placed in a desiccator and subjected a vacuum heat treatment under a working condition comprising a step of cooling down to room temperature, to obtain a heat-resistant tray durable against 450° C.

A 6-inch silicon wafer was disposed on the tray, and sputtering with gold was carried out with a sputtering device. Then, the tray with the silicon wafer on it was transported into a diffusion furnace and subjected to a test in which the tray was maintained under a nitrogen atmosphere at 450° C. for 40 minutes. In this test, good working was carried out without any breakage. Further, the thickness of the gold adhering to the periphery of the tray was about 2 μm. Further, the tray was rapidly cooled down under the above gold-adhering state and no crack and the like occurred in the tray.

### Example 2

A 1.8 mm thick slice substrate of a rosin-wax-impregnated AN1 was obtained in the same manner as in Example 1.

The above substrate was flattened to a thickness of 1.50 mm and processed into a tray shape in the same manner as that of the processing of the cured resin-impregnated substrate in Example 1.

After the processing, the steps of from the removal of the rosin wax to the resin impregnation and curing carried out in Example 1 were carried out.

First, similarly to Example 1, steps of the removal of the rosin wax, cleaning, impregnation with an aluminum chelate compound and the intimate formation of an aluminum oxide on the inner surfaces of open pores were carried out.

Then, the first reduced-pressure impregnation step of the resin R1 was carried out in the same manner as in Example 1. Then, in the second reduced-pressure resin impregnation step, a stepwise heating of 300° C./30 minutes was added to the last hot-air dryer condition.

Then, without carrying out the third impregnation with the resin R1 which was carried out in Example 1, the polybenzimidazole solution impregnation step of Example 1 was carried out as follows. An excess resin on the surface was blown off with a spin coater in place of the wiping off of the surface resin after the impregnation, the resin in the corners of concave portions was wiped off, and a stepwise heating of 300° C./30 minutes was added to the last hot-air drying condition.

Lastly, a vacuum heat-treatment was carried out in the same working condition as that in Example 1, to obtain a heat-resistant tray durable at 450° C.

A 6-inch silicon wafer was disposed on the tray, and sputtering with gold was carried out with a sputtering device. The tray with the silicon wafer on it was transported into a diffusion furnace and subjected to a test in which the tray was maintained under a nitrogen atmosphere at 450° C. for 40 minutes. In this test, good working was carried out without any breakage similarly to Example 1. Further, the thickness of the gold adhering to the periphery of the tray was about 2 μm. Further, the tray was rapidly cooled down under the above gold-adhering state and no crack and the like occurred in the tray.

### Example 3

A 2.5 mm thick slice substrate of a rosin-wax-impregnated AN2 was obtained in the same manner as in Example 1 except that there was used, as an inorganic continuously porous sintered body, a disk having a thickness of 25 mm and a diameter of 250 mm (to be referred to as “AN2” is hereinafter) made an aluminum nitride-boron nitride-based continuously porous sintered body (h-BN content 13%, bulk density 2.70 g/cm³, true porosity 13.0 vol %, average pore diameter 0.48 μm). Then, steps of the removal of the rosin wax, cleaning, impregnation with an aluminum chelate compound and the intimate formation of an aluminum oxide on the inner surfaces of open pores, and steps of impregnation with the Resin R1 and curing by drying were carried out similarly to Example 1, to obtain a resin-impregnated AN2 (to be referred to as “R1-AN2” hereinafter).

The obtained R1-AN2 was surface-polished similarly to Example 1 to give a flattened R1-AN2 having a thickness of 2.0 mm.

The flattened R1-AN2 was processed with a CNC lathe to obtain a disk having an outermost diameter of 201.5 mm. The periphery of its upper surface (mounting part processing surface) was obliquely cut in a 3-mm width such that the outermost thickness became 1 mm, and the disk was processed into a tray shape in which four semiconductor-substrate-mounting parts, each of which corresponded to 3 inches, were equally disposed in the inside thereof. Each mounting part had a center at a position of 57.0 mm from the center of the disk having an outermost diameter of 201.5 mm and had a diameter of 76.5 mm, a depth of 0.5 mm, amounting part inner diameter of 73.0 mm and a bottom face thickness of 1.0 mm, and holes having a diameter of 15 mm and having a center at a position of 25.0 mm from the center of each mounting part were made at four positions in the bottom face.

The above tray was impregnated with a super heat-resistant thermoplastic resin, dried, and cured similarly to Example 1. Then, a vacuum heat-treatment was similarly carried out to obtain a heat-resistant tray durable at 450° C.

A 6-inch silicon wafer was disposed on the tray, and sputtering with gold was carried out with a sputtering device. The tray with the silicon wafer on it was transported into a diffusion furnace and subjected to a test in which the tray was maintained under a nitrogen atmosphere at 450° C. for 40 minutes. In this test, good working was conducted without any breakage. Further, the thickness of the gold adhering to the periphery of the tray was about 2 μm. Further, the tray was rapidly cooled down under the above gold-adhering state and no crack and the like occurred in the tray.

### Example 4

A tray cover having a predetermined size was produced by using a polyimide resin molded article having a ring shape (trade name: Vespel, supplied by DuPont).

The polyimide resin molded article was molded to have an outer diameter of 152 mm, an inner diameter of 148 mm and a thickness of 1.8 mm.

Then, fixing members were made at four positions equally. Each of the fixing members had a width (direction perpendicular to the diameter) of 2 mm and a thickness (diameter direction) of 0.5 mm, was inclined 0.2 mm toward the inside, and had a height of 1.5 mm. The top end part thereof was cut slightly obliquely toward the inside (diameter direction) and a 45° C. incline was formed from an inner portion of a height of a little over 1.0 mm, to have an inside projection cut shape.

There was prepared a tray on which the above tray cover was to be mounted.

As the tray, a tray made of a resin complex ceramic was used. This tray had a total thickness of 1.5 mm, an outermost diameter of 152 mm, a peripheral wall whose height was 0.5 mm and thickness was 0.7 mm, a mounting part diameter of 150 mm, a mounting part width of 1.0 mm, a bottom face thickness of 0.5 mm, an obliquely cut bottom face peripheral part whose width was 1.0 mm and height was 0.5 mm, and had 8 bottom face holes having a size of 30 mm each. The above tray was produced by the technique of Japanese Patent Application No. 2002-283146 which is the present inventors' previous application.

Fixing parts were made at four portions positioned equally in the outer periphery of the tray.

An outer wall portion in width of a little over 2 mm was removed, and a portion below the removed portion was similarly removed. Then, a 45° C. oblique-cut groove was made from the bottom side of the above cut portion to a portion of 0.5 mm.

The above-produced tray cover was mounted on the tray and the degree of fitting in each fixing part was re-adjusted.

Then, the tray cover, which was mounted on the tray, was placed in a furnace set at 300° C. in which a nitrogen gas had been substituted, heated for 30 minutes, temperature-increased up to 450° C., and maintained at 450° C. for 1 hour. Then, a temperature-decreasing program was set, and when the temperature was decreased down to 300° C., the tray cover, which was mounted on the tray, was taken out from the furnace. It was placed in a desiccator and subjected a vacuum heat treatment under a working condition comprising a step of cooling down to room temperature, to obtain a tray cover.

A 6-inch silicon wafer was disposed on the tray, and the tray cover was mounted. Then, sputtering with gold was carried out with a sputtering device. Then, the tray with the tray cover and silicon wafer was transported into a diffusion furnace and subjected to a test in which the tray with the tray cover and silicon wafer was maintained under a nitrogen atmosphere at 450° C. for 40 minutes. In this test, good working was carried out without any breakage. Further, the thickness of the gold adhering to the tray cover was about 2 μm.

Effect of the Invention

As described above, the tray of the present invention carries a semiconductor wafer and can be applied to both a sputtering step and a diffusion step. Further, the tray of the present invention has a thin resin layer strongly bonded to its surface so that the semiconductor wafer is free from the occurrence of scratches caused by rubbing between the semiconductor wafer and the tray in these steps. Therefore, its meaning is remarkably significant.

What is claimed is:

1. A tray for a vapor phase step in which a heat-resistant thermosetting resin is intimately bonded and impregnated to/into surfaces, including inner pore wall surfaces, of an inorganic continuously porous sintered body having a thickness of 0.5 to 10 mm and an open porosity of 5 to 50% and a thin film of a super heat-resistant thermoplastic resin is formed thereon.

2. The tray according to claim 1,
wherein the inorganic continuously porous sintered body is selected from the group consisting of an aluminum nitride-boron nitride (AlN-h-BN) composite, an aluminum nitride-silicon carbide-boron nitride (AlN-SiC-h-BN) composite, a silicon nitride-boron nitride (Si₃N₄-h-BN) composite, an alumina-boron nitride (Al₂O₃-h-BN) composite, β-silicon carbide (β-SiC) and wollastonite.

3. The tray according to claim 1,
wherein the heat-resistant thermosetting resin is selected from resins whose cured products have a thermal decomposition starting temperature of at least 400° C. and the heat-resistant thermoplastic resin is selected from resins which have a thermal decomposition starting temperature of at least 500° C.

4. A process for the production of a tray for a vapor phase step, comprising surface-treating an inorganic continuously porous sintered body having a thickness of 0.5 to 10 mm and an open porosity of 5 to 50% for resin impregnation, impregnating the inorganic continuously porous sintered body with a thermosetting resin to intimately bond the thermosetting resin to surfaces thereof including inner pore wall surfaces, machining the sintered body into a predetermined tray shape, impregnating the machined sintered body with a solution of a super heat-resistant thermoplastic resin as a final impregnation, and subjecting the sintered body to heating, drying and heat-treatment to form a thin super heat-resistant thermoplastic resin layer.

5. A process for the production of a tray for a vapor phase step, comprising impregnating an inorganic continuously porous sintered body having an open porosity of 5 to 50% with a thermally decomposable resin, cutting the sintered body to a thickness of 0.5 to 10 mm, then machining the sintered body into a predetermined tray shape, decomposing and removing the thermally decomposable resin, cleaning the sintered body, surface-treating the sintered body for heat-resistant resin impregnation, impregnating the sintered body with a heat-resistant thermosetting resin to intimately bond the resin to surfaces thereof including inner pore wall surfaces, further impregnating the sintered body with a solution of a super heat-resistant thermoplastic resin, and subjecting the sintered body to heating, drying and heat-treatment to form a thin super heat-resistant thermoplastic resin layer.

6. The process according to claim 4 or 5,
wherein the surface-treatment for heat-resistant resin impregnation is a surface-treatment including the inner pore wall surfaces in which an organic metal compound solution is impregnated, air-dried, dried, heated and thermally decomposed.
